(19) United States
(12) Patent Application Publication
(10) Pub. No.: US 2017/0259682 A1
(43) Pub. Date: Sep. 14, 2017

(54) METHOD AND SYSTEM FOR PROTECTING A CONTACTLESS CHARGING/DISCHARGING PROCESS OF A BATTERY-OPERATED OBJECT, IN PARTICULAR AN ELECTRIC VEHICLE

(71) Applicant: Robert Bosch GmbH, Stuttgart (DE)

(72) Inventors: Gerald Heinrich Oettle, Suzhou (CN); Heiko Sgarz, Leonberg (DE); Joerg Mecks, Beilstein (DE); Markus Mayer, Heilbronn (DE); Martin Pohlmann, Stuttgart (DE)

(21) Appl. No.: 15/509,329

(22) PCT Filed: Jul. 8, 2015
(86) PCT No.: PCT/EP2015/065597

§ 371 Date: Mar. 7, 2017

(30) Foreign Application Priority Data
Sep. 8, 2014 (DE) 10 2014 217 937.8

(51) Int. Cl. B60L 11/18; H02J 7/02

(52) U.S. Cl. CPC B60L 11/1838; B60L 11/182; H02J 7/025; B60L 2230/10

(57) ABSTRACT

The invention relates to a method for protecting a contactless charging/discharging process of a battery-operated object (4), in particular an electric vehicle, wherein the object (4) is charged or discharged by means of inductive energy transmission between a first coil (8) of a charging/discharging station (6) and a second coil (10) of the object (4), wherein a protection area (18, 20) in the surroundings of the charging/discharging station (6) is defined, a detection range (22, 24) of monitoring sensors (16) or an evaluation range of the detection range (22, 24) of monitoring sensors (16) is adjusted to the protection area (18, 20), and the presence of metal and/or persons in the detection range (22, 24) or evaluation range of the monitoring sensors (16) is monitored during a charging/discharging process of the object (4). A computer program and a system (2) which are set up to carry out the method are also stated.

### BACKGROUND OF THE INVENTION

The invention relates to a method for protecting a contactless charging/discharging process of a battery-operated object, in particular an electric vehicle.

A computer program and a system, which are set up for carrying out the method, are also provided.

Battery-operated objects, in particular electric vehicles, require a charging system for charging the battery. The charging system can be designed as a conductive charging system, in which the battery-operated object is connected to the charging/discharging system via a charging cable.

One alternative to such conductive charging systems is in the form of contactless charging systems which provide advantages to the user. In contactless charging systems of this type, an inductive energy transmission takes place between a first coil of a charging station and a second coil of the object, wherein the designations “first” and “second” are arbitrarily selected here and in the following. An air gap, in which magnetic alternating fields having relatively high magnetic flux densities occur, is typically situated between the object and the charging/discharging station in this case.

In systems of this type, there is a need to ensure that living beings, in particular persons, are not endangered during a charging/discharging process.

Therefore, there is a need to detect critical foreign objects in the surroundings of the system, whereby living beings are generally also considered to be persons, in particular.

DE 10 2009 033 236 A1 makes known a device for the inductive transmission of the electric energy from a stationary unit to an electric vehicle, wherein the stationary unit or the electric vehicle comprises a unit for detecting the presence of an object within a predetermined space. The detection device can include ultrasonic radar, infrared sensors, or electronic imaging sensors.

In an IEEE article G. Ombach: Design and Safety Considerations of Wireless Charging System for Automotive; 2014 Ninth International Conference on Ecological Vehicles and Renewable Energies (EVER), radar systems for detecting living beings are described, wherein a detection of movements takes place underneath the vehicle.

### SUMMARY OF THE INVENTION

In one method according to the invention for protecting a contactless charging/discharging process of a battery-operated object, in particular an electric vehicle, wherein the battery-operated object is charged or discharged via inductive energy transmission between a first coil of a charging/discharging station and a second coil of the battery-operated object, it is provided that, on the basis of input information, a protection area in the surroundings of the charging/discharging station is defined, a detection range or an evaluation range of monitoring sensors is set for the protection area, and the presence of metal and/or persons in the detection range or evaluation range of the monitoring sensors is monitored during the contactless charging or discharging of the battery-operated object.

By means of the measures of the invention, a protection area is first defined in the surroundings of the charging/discharging station, i.e., a spatial protection area. In contrast to a device, in the case of which the protection area is determined not on the basis of input information, but rather exclusively by means of the sensor performance, in which a preferably large, i.e., maximum protection area is therefore constantly monitored, the measures of the invention make it possible to lower an erroneous triggering rate of the system, since it is possible to detect or evaluate only those events which are critical for the charging/discharging system or for persons in the vicinity of the charging/discharging system.

Within the scope of the invention, a charging/discharging station is considered to be a station which can be set up both exclusively for charging and exclusively for discharging the battery-operated object. In particular, the term also includes stations, however, which are set up both for charging and for discharging. For example, it can be provided that a complete discharging takes place first and then a charging takes place, depending on the state of the battery-operated object. The invention is not dependent on charging/discharging strategies of this type.

In one step, the detection range of monitoring sensors or the evaluation range of monitoring sensors is set for the protection area. For the case in which the evaluation range of monitoring sensors is set for the protection area, location information regarding a foreign object, for example, is ascertained and, on the basis of the location information, it is determined whether the foreign object is located within or outside of the protection area. If sensor signals containing distance information regarding the object are available, it is therefore possible to set the protection area on the basis of the defined threshold value. If foreign objects are located at a distance from the charging/discharging station, which is greater than the threshold value, a reaction is not triggered.

In one step, the presence of metal and/or persons is monitored, which is also referred to, within the scope of the present disclosure, as foreign object detection, in particular metal detection or living being detection. The metal detection takes place, for example, by means of inductive metal sensors. The living being detection takes place, for example, by detecting movements or by detecting parameters and properties of living beings, such as heat, the water content of the body, reflective properties of light on living beings, or the like.

According to one embodiment of the invention, the protection area is dynamically defined during a charging/discharging process on the basis of input information. A dynamic definition of the protection area is considered to be when the protection area is adapted continuously or in regular time intervals during the charging/discharging process on the basis of input information. The input information is detected, in this case, by sensors for detecting a charging/discharging performance, a coupling quality, a lateral offset between the object and the charging/discharging station, a size of an air gap between the object and the charging/discharging station, and/or for detecting a magnetic flux density in the charging/discharging station.

A dynamic definition of the protection area can take place, for example, on the basis of an ascertained charging/discharging performance, wherein this can be ascertained both in respect of the charging/discharging station and in respect of the battery-operated object.

Alternatively or additionally thereto, the protection area can be dynamically determined on the basis of an ascertained coupling quality of the coils, wherein the coupling quality is typically interrelated with the charging/discharging performance.

Alternatively or additionally thereto, the protection area can be dynamically determined during the charging/discharging process on the basis of an ascertained distance of the object from the charging/discharging station, in particular on the basis of the size of a lateral offset and/or the size of an air gap between the object and the charging/discharging station. GPS, indoor GPS, as well as ultrasonic sensors, radar sensors, LIDAR sensors, or video sensors, for example, can be utilized for measuring the distance of the object from the charging/discharging station. The measurement of the size of the air gap can take place, in particular, by ascertaining the signal transit time of an ultrasonic signal.

Alternatively or additionally thereto, the protection area can be dynamically defined during the charging/discharging process on the basis of the measurement of a magnetic flux density in the charging/discharging station. The measurement of the magnetic flux density can take place, in this case, via external sensors, for example, magnetic field sensors, in the charging/discharging station or in the battery-operated object or outside of the system, i.e., outside of the charging/discharging station. Hall sensors are suitable, in particular, as magnetic field sensors.

In one alternative embodiment, the protection area can be defined once before the charging/discharging process on the basis of input information. This preferably takes place on the basis of properties of the battery-operated object, for example, on the basis of a defined nominal charging/discharging performance, which can be defined, for example, at a level of 22 kW, 7 kW or 3.5 kW, and/or by ascertaining the effect of the object size on the distance from the charging/discharging station to the object. Vehicle properties are an option in the case of electric vehicles. Vehicle properties of this type can be defined, for example, by vehicle classes (e.g., small cars, SUVs), vehicle sizes, and vehicle contours.

According to one embodiment of the invention, the protection area can set in discrete steps. This can result in a particularly cost-effective implementation of the invention. In this case, systems can be provided, which are developed in respect of exactly two, three, or four protection areas, in particular, for example, in respect of a first mode, in which a close range is monitored, and a second mode, in which a close range and a far range are monitored. As soon as the protection areas vary due to different magnetic leakage fields of the charging/discharging system or due to the distance of the charging/discharging station from the object, the protection area to be monitored changes.

According to one embodiment, the detection area of the monitoring sensors is set after a transmission power is set. The detection range of the sensor can be regulated via the transmission power in a system which is based on radar sensors, in particular. The transmission power is increased for a greater range and the transmission power is reduced for a smaller range. Alternatively, the sensitivity can be changed via other sensor-specific parameters.

According to one preferred embodiment, interferences are taken into account as one further input variable in the adjustment of the transmission power of the monitoring sensors, for example, a water film on a sensor, which limits the range of the sensor, or any other type of contamination. In this case, the environmental influences are detected in a first step, for example, and, in a second step, the transmission power of the monitoring sensors is set on the basis of the ascertained interferences and the defined protection area.

According to one preferred embodiment, if the presence of metal and/or persons is detected in the detection range or evaluation range of the monitoring sensors, a reaction takes place, in the form of a shutoff of the charging/discharging process, a temporary or conditional interruption of the charging/discharging process, a reduction of the charging/discharging performance of the charging/discharging process, an output of a corresponding output signal which can be further processed by further control units, and/or an output of a visual or acoustic warning signal. A conditional interruption can be lifted if the condition occurs that the detected metal piece or the relevant person steps outside of the detection range or evaluation range of the monitoring sensors again.

The information regarding the detected presence of metal and/or persons in the detection range or evaluation range of the monitoring sensors can be transmitted, for example, to a control device which can be provided both on the side of the battery-operated object and on the side of the charging/discharging station. The control unit carries out the reaction of the entire system. In this case, mandatory reactions can be provided, such as switching off the power transmission, for example in the case of metal detection or a detection of living beings in the protection area, and optional additional reactions, such as, for example, reducing the power if a living being merely approaches.

According to one further aspect, a computer program is provided, according to which one of the methods described herein is carried out, wherein the computer program is run on a programmable computer device. The computer program can be, for example, a software module, a software routine, or a software subroutine for implementing a charging/discharging system comprising a battery-operated object and a charging/discharging station. The computer program can be stored on the battery-operated object, on the charging/discharging station, or distributed thereon, in particular on permanent or rewritable storage media, or via assignment to a computer device, for example, on a portable memory, such as a CD-ROM, DVD, Bluray disk, a USB stick or a memory card. In addition or alternatively thereto, the computer program can be provided on a computer device, such as, for example, on a server or on a cloud server, for downloading, for example via a data network, such as the Internet, or via a communication connection, such as a telephone line or a wireless connection.

According to one further aspect of the invention, a system comprising a charging/discharging station and a battery-operated object, in particular an electric vehicle, is provided, wherein the charging/discharging station and the battery-operated object comprise coils for charging and/or discharging. The system also includes monitoring sensors for detecting the presence of metal and/or persons in the surroundings of the charging/discharging station. The system also includes a control unit which is set up for defining a protection area in the surroundings of the charging/discharging station on the basis of input information, setting a detection range or an evaluation range of the monitoring sensors for the protection area, and monitoring a presence of metal and/or persons in the detection range or evaluation range of the monitoring sensors during a charging/discharging process of the battery-operated object.

Preferably, the system is designed and/or set up for carrying out the described methods. Therefore, the features described within the scope of the methods apply similary for the system and, conversely, the features described within the scope of the system apply similarly for the methods.

The control unit can be assigned to the charging/discharging station or to the battery-operated object. Alternatively, it can be provided that both the battery-operated object and the charging/discharging station are equipped with control units which jointly carry out the method according to the invention.

According to further aspects of the invention, a charging/discharging station, and a battery-operated object are provided for use in a system of this type.

The terms “battery” and “battery-operated” are utilized for “accumulator” and “accumulator-operated”, respectively, in the present description, in accordance with common parlance. In the battery, the battery cells are preferably grouped together spatially and are connected to each other in a circuit, for example being interconnected in series or in parallel to form modules, in order to provide the required power data using the battery cells.

In particular, the battery-operated object can be a motor vehicle, wherein its battery is connected to a drive system of the motor vehicle. The motor vehicle can be designed as a pure electric vehicle and can exclusively include an electric drive system. Alternatively, the motor vehicle can be designed as a hybrid vehicle which includes an electric drive system and an internal combustion engine. In some variants, it can be provided that the hybrid vehicle is externally chargeable (PHEV, i.e., a plug-in hybrid electric vehicle).

The monitoring sensors preferably comprise radar sensors, infrared sensors, ultrasonic sensors, a video system and/or inductive metal detection sensors. Heat sensors which can detect the heating of the metal pieces can also be provided. The adjustment of the monitoring ranges can therefore be applied both for the detection of living beings and for the inductive metal detection.

Ultrabroadband radar sensors having a frequency bandwidth of at least 500 MHz, preferably at least 1 GHz, are preferred in this case. Bandwidths of this type allow for better separability and a multitarget resolution of objects. Radar sensors having a frequency range from 2 to 24 GHz, preferably from 3.1 to 4.8 GHz or from 6 to 8.5 GHz are also preferable. Alternatively, radar sensors having a frequency range from 76 to 81 GHz are particularly preferable. At these higher frequencies, smaller antenna can be utilized, in principle, which can result in a smaller installation space for the sensor. A higher carrier frequency also allows for a better Doppler resolution which can be utilized for a greater accuracy in measurements of speed and distance.

The present invention provides a method for the one-time or dynamic adaptation of protection areas in contactless charging/discharging systems. The presented system allows for both object detection, specifically metal detection, and living being detection.

### BRIEF DESCRIPTION OF THE DRAWINGS

Exemplary embodiments of the invention are represented in the drawings and are described in greater detail in the following description. In the drawings:

FIG. 1 shows a side view of a system comprising a battery-operated object and a charging/discharging station according to one embodiment of the invention, and

FIG. 2 shows a top view of the system from FIG. 1.

### DETAILED DESCRIPTION

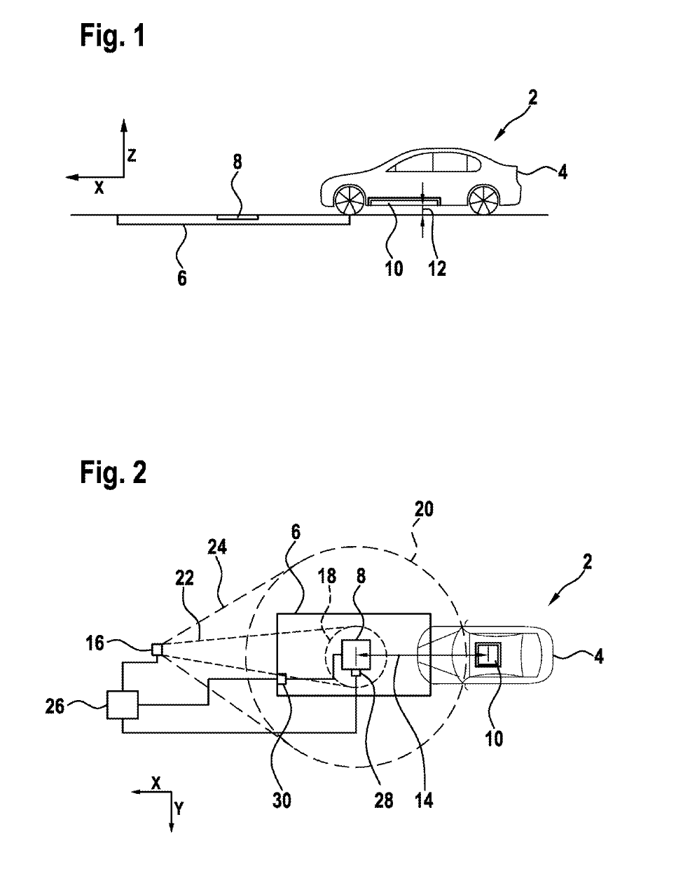

FIG. 1 shows a system 2 comprising a battery-operated object 4 and a charging/discharging station 6. The battery-operated object 4, which is an electric vehicle in this case, by way of example, is also referred to in the following as an object 4, for short.

The charging/discharging station 6 comprises a first coil 8. The object 4 comprises a second coil 10. The first and second coils 8, 10 can each also be formed by multiple individual coils 8, 10 which are combined with each other, i.e., by a coil system. The object 4 is charged and/or discharged by means of inductive energy transmission via the coils 8, 10.

In the contactless charging or discharging process, an air gap 12 typically exists between the object 4 and the charging/discharging station 6, the size of which influences a coupling quality of the coils 8, 10. For charging, the object 4 is therefore positioned with its second coil 10 preferably exactly over the first coil 8 of the charging/discharging station 6, in order to maximize the coupling.

FIG. 2 shows the system 2 from FIG. 1 in a top view, wherein a monitoring sensor 16, a control unit 26, and an input information sensor 28, which are assigned to the system 2, are also represented here. In FIG. 2, the monitoring sensor 16, the control unit 26, and the input information sensor 28 are shown outside the vehicle. This is not limiting for the invention. Alternatively, the monitoring sensor 16, the control unit 26 and/or the input information sensor 28 can also be assigned to the object 4, for example, as a sensor system on the vehicle underbody. Alternatively, an integration into a charging pad on the infrastructure side can be provided.

The object 4 is situated with a lateral offset 14 from the charging/discharging station 6. As is also the case with the air gap 12, the lateral offset 14 is a parameter which influences the coupling quality of the coils 8, 10. The lateral offset 14 can be defined in respect of arbitrary parameters of the object 4 and the charging/discharging station 6, in particular also in respect of the coils 8, 10. For example, a lateral offset 14 of zero can be assumed when the second coil 10 is situated directly over the first coil 8.

The system 2 includes monitoring sensors 16, wherein only one monitoring sensor 16 is represented here, by way of example. In general, a multiplicity of monitoring sensors 16 is provided, in order to detect the surroundings of the battery-operated object 4 and of the charging/discharging station 6 in detail. The monitoring sensors 16 can include ultrasonic sensors, radar sensors, infrared sensors, a video system and metal detection sensors, for example ultrabroadband radar sensors.

The system 2 includes a first protection area 18 and a second protection area 20 which are represented as spaces having a uniform distance from the charging/discharging station 6 and from the first coil 8. In embodiments which are not represented, the protection areas 18, 20 can also relate to surroundings of the second coil 10 of the object 4 or to shared surroundings of the first coil 8 and the second coil 10. In the latter case, the protection areas 18, 20 can be defined as spaces, for example, which are delimited by a constant summed distance to the two coils 8, 10, i.e., by ellipsoids.

Assigned to the first protection area 18 is a first detection range 22 of the monitoring sensor 16. Assigned to the second protection area 20 is a second detection range 24 of the monitoring sensor 16, which is larger than the first detection range 22. The size of the detection ranges 22, 24 of the monitoring sensor 16 can be adjusted, for example, by regulating the transmission power. Alternatively, an evaluation range of the detection range 22, 24 can be defined.

The monitoring sensor 16 is controlled by the control unit 26 in order to define the detection range 22, 24. The control unit 26 processes data and/or measured values from the input information sensor 28 as input variables for the control, i.e., as a basis for decision making, so to speak. It is generally provided in this case that more than one input information sensor 28 is used, even though only one input information sensor 28 is represented in FIG. 2. The input information sensors 28 can include, for example, sensors for detecting the charging/discharging, the coupling quality, the lateral offset 14 between the object 4 and the charging/discharging station 6, for detecting the size of the air gap 12 between the object 4 and the charging/discharging station 6, or for detecting the magnetic flux density in the charging/discharging station 6, or said input information sensors can include communication means which detect a nominal charging/discharging performance or, for example, vehicle parameters.

The protection area 18, 20 and the detection range 22, 24 are set by the control unit 26 on the basis of input information ascertained by the input information sensors 28. For the case in which, for example, the measured charging/discharging performance, the coupling quality, or the magnetic flux density in the charging/discharging station 6 are greater than corresponding defined threshold values, the control unit 26 sets the system 2 for the larger, second protection area 20 and the larger, second detection range 24. Likewise for the case in which, for example, the measured lateral offset 14 between the object 4 and the charging/discharging station 6 or the measured size of the air gap 12 between the object 4 and the charging/discharging station 6 is smaller than the corresponding defined threshold values, the control unit 26 sets the system 2 to the larger, second protection area 20 and the larger, second detection range 24. For the case in which it was ascertained that a small vehicle is supposed to be charged, the control unit 26 sets the system 2 for the smaller, first protection area 18 and the smaller, first detection range 22; for the case of a large vehicle, said system is set for the larger, second protection area 20 and the larger, second detection range 24.

The control unit 26 is also connected to a control circuit 30 of the charging/discharging station 6, wherein, in alternative embodiments, a control circuit 30 of this type can also be provided in the object 4. The control unit 26 processes the information from the monitoring sensor 16 and controls the control circuit 30 on the basis of the measured values or data from the monitoring sensor 16, and so, if the presence of metal and/or persons in the detection range 22, 24 of the monitoring sensors 16 is detected, a reaction can take place, in the form of a shutoff of a charging/discharging process, an interruption of the charging/discharging process, a reduction of the charging/discharging performance of the charging/discharging process, an output of a corresponding output signal which can be further processed by further control units (not represented), and/or an output of a visual or acoustic warning signal.

The invention is not limited to the exemplary embodiments described here or to the aspects emphasized therein. Rather, a plurality of modifications, which do not go beyond the normal abilities of a person skilled in the art, are possible within the scope indicated by the claims.

1. A method for protecting a contactless charging/discharging process of a battery-operated object (4), wherein the battery-operated object (4) is charged or discharged via inductive energy transmission between a first coil (8) of a charging/discharging station (6) and a second coil (10) of the battery-operated object (4), including the steps:
defining a protection area (18, 20) in the surroundings of the charging/discharging station (6) on the basis of input information,
setting a detection range (22, 24) of monitoring sensors (16) or an evaluation range of the detection range (22, 24) of monitoring sensors (16) for the protection area (18, 20) and
monitoring the presence of metal and/or persons in the detection range (22, 24) or evaluation range of the monitoring sensors (16) during a charging/discharging process of the battery-operated object (4).

2. The method as claimed in claim 1, characterized in that the protection area (18, 20) is defined during the charging/discharging process on the basis of an ascertained charging/discharging performance, and ascertained coupling quality of the first and second coils (8, 10), an ascertained distance of the battery-operated object (4) from the charging/discharging station (6), and the size of an air gap (12) between the battery-operated object (4) and the charging/discharging station (6), and on the basis of the measurement of a magnetic flux density in the charging/discharging station (6).

3. The method as claimed in claim 1, characterized in that the protection area (18, 20) is defined on the basis of properties of the battery-operated object (4).

4. The method as claimed in claim 1, characterized in that the protection area (18, 20) is settable in discrete steps.

5. The method as claimed in claim 1, characterized in that the detection range (22, 24) of the monitoring sensors (16) is set by adjusting a transmission power of the monitoring sensors (16).

6. The method as claimed in claim 5, characterized in that interferences are taken into account as a further input parameter in the adjustment of the transmission power of the monitoring sensors (16).

7. The method as claimed in claim 1, characterized in that, if the presence of metal and/or persons is detected in the detection range (22, 24) or evaluation range of the monitoring sensors (16), a reaction takes place, in the form of a shutoff of the charging/discharging process, a temporary or conditional interruption of the charging/discharging process, a reduction of the charging/discharging performance of the charging/discharging process, an output of a corresponding output signal which can be further processed by further control units, and/or an output of a visual or acoustic warning signal.

8. A non-transitory computer readable medium including a computer program for carrying out the method as claimed in claim 1, when the computer program is run on a programmable computer device.

9. A system (2) comprising a charging/discharging station (6), a battery-operated object (4), wherein the charging/discharging station (6) and the battery-operated object (4) comprise coils (8, 10) for charging and/or discharging, monitoring sensors (16) for detecting the presence of metal and/or persons in the surroundings of the charging/discharging station (6), and a control unit (26), wherein the control unit (26) is set up to define a protection area (18, 20) in the surroundings of the charging/discharging station (6) on the basis of input information, to set a detection range (22, 24) or an evaluation range of the monitoring sensors (16) for the protection area (18, 20) and, during a charging/discharging process of the battery-operated object (4), to monitor a presence of metal and/or persons in the detection range (22, 24) or evaluation range of the monitoring sensors (16).

10. The system (2) as claimed in claim 9, characterized in that the monitoring sensors (16) include radar sensors, infrared sensors, a video system and/or inductive metal detection sensors.

11. The method as claimed in claim 1, wherein the battery-operated object (4) is an electric vehicle.

12. The method as claimed in claim 2, wherein the ascertained distance of the battery-operated object (4) from the charging/discharging station (6), is based on the basis a size of a lateral offset (14).

13. The method as claimed in claim 1, characterized in that the protection area (18, 20) is defined during the charging/discharging process on the basis of an ascertained charging/discharging performance, and ascertained coupling quality of the first and second coils (8, 10), and an ascertained distance of the battery-operated object (4) from the charging/discharging station (6).

14. The method as claimed in claim 1, characterized in that the protection area (18, 20) is defined during the charging/discharging process on the basis of an ascertained charging/discharging performance, and ascertained coupling quality of the first and second coils (8, 10), and the size of an air gap (12) between the battery-operated object (4) and the charging/discharging station (6).

15. The method as claimed in claim 1, characterized in that the protection area (18, 20) is defined during the charging/discharging process on the basis of an ascertained charging/discharging performance, and ascertained coupling quality of the first and second coils (8, 10), and on the basis of the measurement of a magnetic flux density in the charging/discharging station (6).

16. The system (2) as claimed in claim 9, wherein the battery-operated object (4) is an electric vehicle.

17. The system (2) as claimed in claim 10, wherein the radar sensors have a frequency bandwidth of at least 500 MHz.

18. The system (2) as claimed in claim 10, wherein the radar sensors have a frequency bandwidth of at least 1 GHz.

19. The system (2) as claimed in claim 10, wherein the radar sensors have a frequency range of 2 to 24 GHz.

20. The system (2) as claimed in claim 10, wherein the radar sensors have a frequency range from 76 to 81 GHz.
